(19) United States
(12) Patent Application Publication
(10) Pub. No.: US 2025/0055046 A1
(43) Pub. Date: Feb. 13, 2025

(54) ELECTRODE ASSEMBLY AND BATTERY

(71) Applicant: Zhuhai CosMX Battery Co., Ltd., Zhuhai (CN)

(72) Inventors: Jian ZHANG, Zhuhai (CN); Chong PENG, Zhuhai (CN)

(21) Appl. No.: 18/931,386

(22) Filed: Oct. 30, 2024

Related U.S. Application Data
(63) Continuation of application No. PCT/CN2023/116274, filed on Aug. 31, 2023.

(30) Foreign Application Priority Data
Oct. 26, 2022 (CN) 202211322328.6

(51) Int. Cl. H01M 10/42; H01M 4/02; H01M 4/62

(52) U.S. Cl. CPC H01M 10/4235; H01M 4/622; H01M 2004/021; H01M 2004/027; H01M 2004/028

(57) ABSTRACT

Provided are an electrode assembly and a battery. The electrode assembly includes a positive electrode piece formed by winding, including a positive electrode current collector and a functional layer, where the positive electrode current collector includes a first surface and a second surface which are parallel and opposite to each other, and the first and second surfaces of the positive electrode current collector are each provided with a functional layer; a length of the functional layer is the same as that of the positive electrode current collector; the functional layer includes a positive electrode active material layer, and a protective layer which is arranged between the positive electrode current collector and the positive electrode active material layer, and a length of the protective layer is smaller than or equal to that of the positive electrode active material layer; the protective layer includes a conductive material and a binder.

### CROSS-REFERENCE TO RELATED APPLICATIONS

The present application is a continuation of International Application No. PCT/CN2023/116274, filed on Aug. 31, 2023, which claims priority to Chinese Patent Application No. 202211322328.6, entitled “ELECTRODE ASSEMBLY AND BATTERY”, and filed with the China National Intellectual Property Administration on Oct. 26, 2022. The disclosures of the aforementioned applications are hereby incorporated by reference in their entireties.

### TECHNICAL FIELD

The present application relates to an electrode assembly and a battery, and relates to the technical field of batteries.

### BACKGROUND

A battery includes an electrode assembly capable of carrying out electrochemical reactions and a housing that seals the electrode assembly. When the battery is subjected to mechanical abuse such as needle puncture, extrusion, etc., a serious short circuit will occur inside the electrode assembly, causing battery failure and thermal runaway, and posing a potential safety hazard to the use of the battery.

The most common short circuit situations include: a short circuit between a positive electrode current collector and a negative electrode current collector, a short circuit between the positive electrode current collector and a negative active material layer, a short circuit between a positive active material layer and the negative electrode current collector, and a short circuit between the positive active material layer and the negative active material layer. Among them, when the short circuit occurs between the positive electrode current collector and the negative active material layer, the heat generation is the fastest, which is most likely to cause thermal runaway, posing a greater safety hazard.

### SUMMARY

The present application provides an electrode assembly for solving the problem of easy occurrence of a short circuit between a positive electrode current collector and a negative electrode active material layer when the battery is subjected to mechanical abuse, thereby improving the safety performance of the battery.

A first aspect of the present application provides an electrode assembly, including a positive electrode piece formed by winding, and the positive electrode piece includes a positive electrode current collector and functional layers, where:
the positive electrode current collector includes a first surface and a second surface which are parallel and opposite to each other, the first surface and the second surface of the positive electrode current collector are each provided with a functional layer, and a length of the functional layer is the same as a length of the positive electrode current collector;
the functional layer includes a protective layer and a positive electrode active material layer, the protective layer is arranged between the positive electrode current collector and the positive electrode active material layer, and a length of the protective layer is less than or equal to a length of the positive electrode active material layer;
the protection layer includes a conductive material and a binder.

In a specific embodiment, the length of the protective layer is less than or equal to the length of the positive electrode current collector.

In a specific embodiment, a thickness of the protective layer is 1-10 μm.

In a specific embodiment, a resistance of the protective layer is 10-2000 mΩ.

In a specific embodiment, a peeling force between the protective layer and the positive electrode current collector is greater than a peeling force between the protective layer and the positive electrode active material layer.

In a specific embodiment, the conductive material includes a first conductive material and/or a second conductive material. The first conductive material includes one or more of SnO₂, In₂O₃, Sb-doped SnO₂, F-doped SnO₂, or Sn-doped In₂O₃. The second conductive material includes a matrix particle and a coating layer for coating a surface of the matrix particle, and the matrix particle is one or more material selected from aluminum oxide, magnesium oxide, titanium oxide, zinc oxide, silicon oxide, boehmite, cobalt oxide, iron phosphate, lithium iron phosphate, lithium nickel cobalt manganese oxide, or lithium iron manganese phosphate. The coating layer includes one or more of carbon, SnO₂, In₂O₃, Sb-doped SnO₂, F-doped SnO₂, or Sn-doped In₂O₃.

In a specific embodiment, a mass of the coating layer is 5-40% of a total mass of the second conductive material.

In a specific embodiment, a Dv50 of the conductive material is 0.05-5 μm.

In a specific embodiment, a resistivity of the conductive material is 1-100 Ω·cm.

In a specific implementation, a mass of the conductive material is 40%-98% of a total mass of the protective layer.

In a specific embodiment, a mass of the binder is 2-60% of a total mass of the protective layer.

In a specific embodiment, the binder includes one or more of polyvinylidene fluoride, acrylic acid-modified polyvinylidene fluoride, polyacrylate, polyimide, styrene-butadiene rubber, or styrene-propylene rubber.

A second aspect of the present application provides a battery, including any of the electrode assemblies described above.

The implementation of the present application has at least the following advantages.

1. The present application can eliminate the non-coated foil zones on the surfaces of the positive electrode current collector, reduce the risk of short circuit between the positive electrode current collector and the negative electrode active material layer, and improve the safety performance of the battery by simultaneously arranging the functional layers on the upper surface and the lower surface of the positive electrode current collector, and making the length of the functional layer the same as the length of the positive electrode current collector; at the same time, the protective layer includes a conductive material, which can take into account the conductivity of the positive electrode piece and improve the cycle performance of the battery.

2. The battery provided by the present application includes the above-mentioned electrode assembly, and has good safety performance and cycle performance.

### BRIEF DESCRIPTION OF DRAWINGS

In order to illustrate the technical solutions in the embodiments of the present application or in the prior art more clearly, the drawings required in the description of the embodiments or in the prior art will be briefly introduced below. Obviously, the drawings in the following description are only some embodiments of the present application. For the person skilled in the art, other drawings may also be obtained based on these drawings without creative work.

FIG. 1 is a structurally schematic diagram of an electrode assembly provided by the prior art.

FIG. 2 is a structurally schematic diagram of a positive electrode piece provided by the prior art.

FIG. 3 is a structurally schematic diagram of an electrode assembly provided by an embodiment of the present application.

FIG. 4 is a structurally schematic diagram of a positive electrode piece provided by an embodiment of the present application.

FIG. 5 is a structurally schematic diagram of a positive electrode piece provided by another embodiment of the present application.

FIG. 6 is a structurally schematic diagram of the electrode assembly provided by comparative examples 1-5 of the present application.

### DESCRIPTION OF REFERENCE SIGNS

101—positive electrode current collector;
a—first surface;
b—second surface;
102—positive electrode active material layer;
103—protective layer;
104—functional layer;
201—negative electrode current collector;
202—negative electrode active material layer;
300—positive electrode tab;
400—negative electrode tab.

### DESCRIPTION OF EMBODIMENTS

In order to make the purpose, technical solutions and advantages of the present application clearer, the technical solutions in the present application will be clearly and completely described below in combination with the embodiment in the present application. Obviously, the described embodiments are part of the embodiments of the present application, but not all of them. Based on the embodiments in the present application, all other embodiments obtained by the person skilled in the art without creative work fall within the protection scope of the present application.

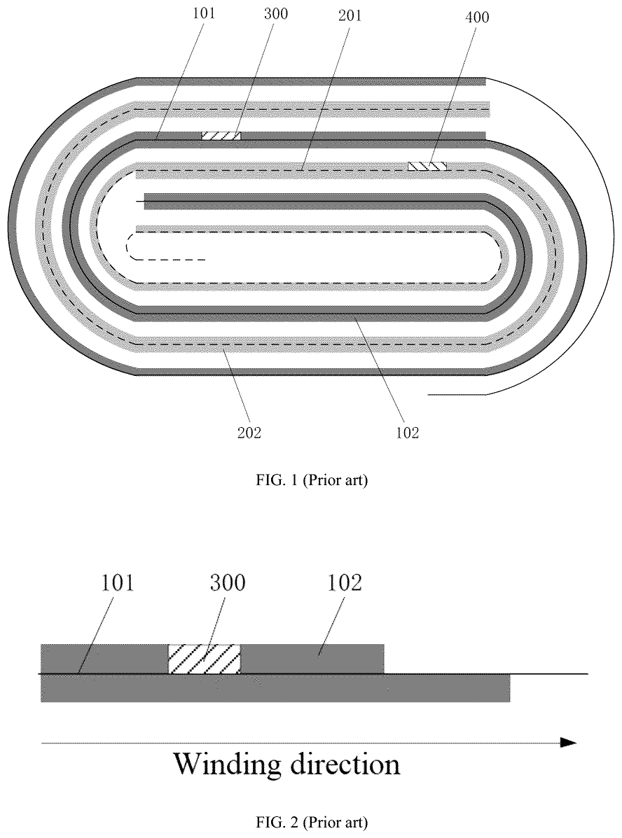

FIG. 1 is a structural schematic diagram of an electrode assembly provided by the prior art, and FIG. 2 is a structural schematic diagram of a positive electrode piece provided by the prior art. As shown in FIG. 1 and FIG. 2, an electrode assembly includes a positive electrode piece and a negative electrode piece which are wound from the inside to the outside, and a separator (not shown in the figures) is provided between the positive electrode piece and the negative electrode piece to prevent a short circuit between them. However, when a battery is subjected to mechanical abuse, the separator ruptures, which is prone to a short circuit between the positive electrode piece and the negative electrode piece, causing thermal runaway, and posing a potential safety hazard to the use of battery.

According to the winding mode of the electrode piece, in the present application, the internal part of the electrode assembly serves as a starting point of winding, the electrode piece is wound and formed from the inside to the outside along its length direction, and the closing position of the electrode assembly serves as a finishing point of winding. According to FIG. 1 to FIG. 2, it can be seen that a large number of non-coated foil zones exist on the surface of a positive electrode current collector 101 close to the finishing point of winding. When the battery is subjected to mechanical abuse, there is prone to a short circuit between the positive electrode current collector 101 located on the outer circle of the electrode assembly and a negative electrode active material layer 202, which is most likely to cause thermal runaway and forms a weak region for safety.

Based on the above analysis, both surfaces of the positive electrode current collector in the present application are each provided with a functional layer, and the non-coated foil zone on the surface of the positive electrode current collector are completely covered by the functional layer. That is, the positive electrode current collector includes a first surface and a second surface that are parallel and opposite to each other, and each of the first surface and the second surface of the positive electrode current collector is provided with the functional layer, and the length of the functional layer is the same as the length of the positive electrode current collector.

The functional layer includes a protective layer and a positive electrode active material layer. The protective layer is arranged between the positive electrode current collector and the positive electrode active material layer. The length of the protective layer is less than or equal to the length of the positive electrode active material layer.

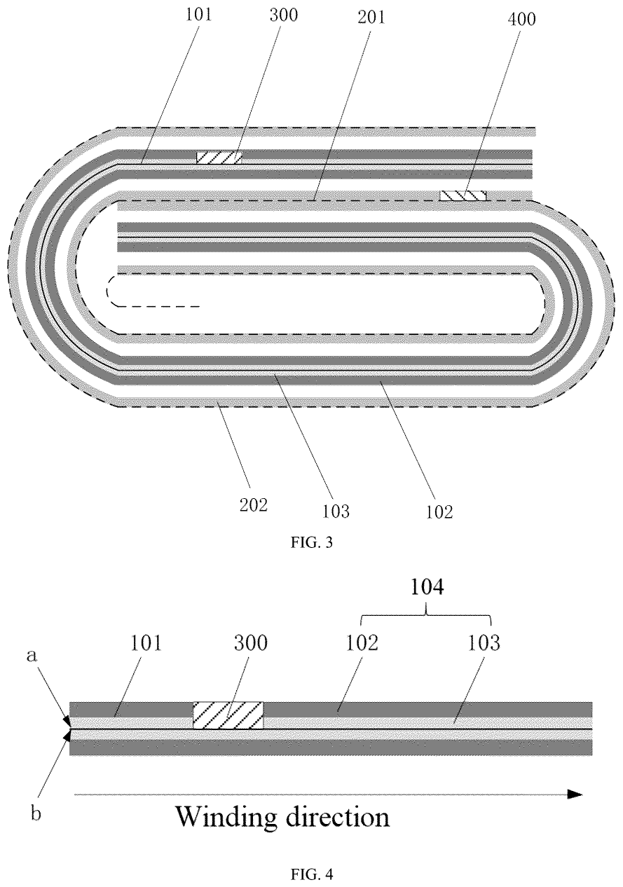

FIG. 3 is a structural schematic diagram of an electrode assembly provided by an embodiment of the present application, and FIG. 4 is a structural schematic diagram of a positive electrode piece provided by an embodiment of the present application. As shown in FIG. 3 to FIG. 4, the electrode assembly includes a positive electrode piece wound from the inside to the outside, and the positive electrode piece includes a positive electrode current collector 101 and a functional layer 104, where the positive electrode current collector 101 includes a first surface a and a second surface b that are parallel and opposite to each other, and functional layers 104 are arranged on the surfaces of the positive electrode current collector 101, the first surface a and the second surface b. The functional layer 104 includes a protective layer 103 and a positive electrode active material layer 102, with the protective layer 103 provided between the positive electrode current collector 101 and the positive electrode active material layer 102. That is, the protective layer 103 is arranged on each of the first surface a and the second surface b of the positive electrode current collector 101, the positive electrode active material layer 102 is arranged on the surface of the protective layer 103 away from the positive electrode current collector 101, the first surface a and the second surface b of the positive electrode current collector are each provided with the protective layer 103 and the positive electrode active material layer 102 which are laminated in sequence, and the lengths of the positive electrode current collector 101, the protective layer 103 and the positive electrode active material layer 102 are the same.

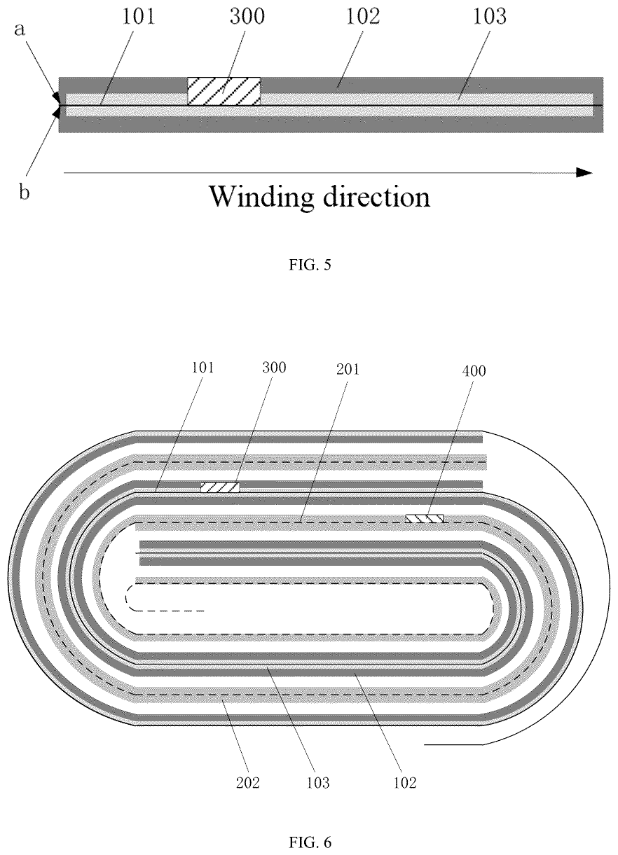

FIG. 5 is a structural schematic diagram of a positive electrode piece provided by another embodiment of the present application. As shown in FIG. 5, the length of the positive electrode current collector 101 is the same as that of the positive electrode active material layer 102, and the length of the protective layer 103 is smaller than the length of the positive electrode current collector 101 and the length of the positive electrode active material layer 102. This is because the positive electrode active layer slurry will inevitably flow to the two ends of the protective layer 103 during the coating process, forming the structure shown in FIG. 5.

In order to take into account the conductivity of the positive electrode piece, the protective layer includes a conductive material and a binder. On the one hand, the conductive material can act as a filler. When the battery is subjected to mechanical abuse such as needle puncture and foreign body extrusion, the conductive material can function as a barrier to prevent a short circuit between the burr generated by the positive electrode current collector and the negative electrode active material layer. On the other hand, the conductive material can also play a conductive role, and construct a good conductive network, so that the protective layer maintains stable conductivity during the charge and discharge process of battery, improving the cycling performance of the battery. The binder has an effect of bonding, and can perform bonding between the conductive materials, between the protective layer and the positive electrode current collector, and between the protective layer and the positive electrode active material layer.

In an embodiment, the protective layer 103 is composed of a conductive material and a binder, excluding any ingredients other than the conductive material and the binder, for example non-conductive material, which helps to balance the conductivity of the positive electrode piece and the cycle performance of the battery on the basis of improving the safety performance of the battery.

Therefore, the present application can eliminate the non-coated foil zones on the surface of the positive electrode current collector, reduce the risk of short circuit between the positive electrode current collector and the negative electrode active material layer, and improve the safety performance of the battery by simultaneously arranging the functional layers on both the upper surface and the lower surface of the positive electrode current collector, and making the length of the functional layer the same as the length of the positive electrode current collector; at the same time, the protective layer includes a conductive material, which can take into account the conductivity of the positive electrode piece and improve the cycle performance of the battery.

It can be understood that as the thickness of the protective layer 103 increases, its protective effect on the positive electrode current collector 101 becomes better when the battery is subjected to mechanical abuse. However, as the thickness of the protective layer increases, it is easy to affect the energy density of the battery. Therefore, in order to balance the safety and energy density of the battery, the thickness of the protective layer is 1-10 μm, for example, 1 μm, 1.5 μm, 2 μm, 3 μm, 4 μm, 5 μm, 8 μm, 10 μm or a range composed of any two thereof. Further, the thickness of the protective layer 103 is 2-5 μm.

In order to further improve the protective effect of the protective layer 103 on the positive electrode current collector 101, the peeling force between the protective layer 103 and the positive electrode current collector 101 should be greater than the peeling force between the protective layer 103 and the positive electrode active material layer 102. When the battery is subjected to mechanical abuse, the protective layer 103 is not easy to lead to failure due to falling off from the surface of the positive electrode current collector 101. Specifically, the binder content in the protective layer 103 may be increased to be greater than the binder content in the positive electrode active material layer 102, or the adhesion of the binder in the protective layer 103 may also be increased to be stronger than the adhesion of the binder in the positive electrode active material layer 102.

In order to take into account the conductivity of the positive electrode piece, the resistance of the protective layer is 10-2000 mΩ, for example, 10 mΩ, 20 mΩ, 50 mΩ, 100 mΩ, 500 mΩ, 1000 mΩ, 1500 mΩ, 2000 mΩ or a range composed of any two thereof. The resistance refers to a resistance in the thickness direction of the protective layer, which may be obtained by testing with a bulk resistivity meter, where the probe of the bulk resistivity meter has a diameter of 15 mm. During the test, the bulk resistance of the current collector is tested first, which is denoted as R1, and then the bulk resistance of the electrode piece of the protective layer plus the current collector is tested, which is denoted as R2, so that the bulk resistance of the protective layer in its thickness direction R=R2−R1; further, the resistance of the protective layer is 100-1000 mΩ, for example, 100 mΩ, 200 mΩ, 300 mΩ, 350 mΩ, 400 mΩ, 500 mΩ, 800 mΩ, 1000 mΩ or a range composed of any two thereof.

In a specific embodiment, the conductive material includes a first conductive material and/or a second conductive material. The first conductive material includes one or more of SnO₂, In₂O₃, Sb-doped SnO₂ (ATO), F-doped SnO₂ (FTO), or Sn-doped In₂O₃ (ITO). The second conductive material includes a matrix particle and a coating layer for coating the surface of the matrix particle. The matrix particle is one or more material selected from aluminum oxide, magnesium oxide, titanium oxide, zinc oxide, silicon oxide, boehmite, cobalt oxide, iron phosphate, lithium iron phosphate, lithium nickel cobalt manganese oxide, or lithium iron manganese phosphate. The coating layer includes one or more of carbon, SnO₂, In₂O₃, Sb-doped SnO₂, F-doped SnO₂, or Sn-doped In₂O₃. Both the doping and coating modes may adopt conventional technical means in the art. The mass of the coating layer is 5-40% of the total mass of the second conductive material, otherwise, if the content of the coating layer is too low, it is likely to affect the conductive effect of the conductive material, and further affect the cycle performance of battery.

Further, the conductive material is a second conductive material. Furthermore, the matrix particle is one or more material selected from aluminum oxide, magnesium oxide, titanium oxide, zinc oxide, silicon oxide, boehmite, cobalt oxide, or iron phosphate. The coating layer is formed from Sb-doped SnO₂, where the mass of the coating layer is 5%-40% of the total mass of the second conductive material.

Further, the Dv50 of the conductive material is 0.05-5 μm, for example, 0.05 μm, 0.10 μm, 0.15 μm, 0.20 μm, 0.50 μm, 1.0 μm, 2.0 μm, 5.0 μm or in a range composed of any two thereof. Furthermore, the Dv50 of the conductive material is 0.1-1 μm. Dv50 refers to the granularity corresponding to 50% of the cumulative volume distribution in the volume distribution of the conductive material, which may be obtained according to the detection of a granularity analyzer. By limiting the granularity of the conductive material, the conductive material can be better adhered to the positive electrode current collector, thereby improving the protective effect of the protective layer on the positive electrode current collector, and taking into account the thickness limitation of the protective layer and the processing difficulty of the electrode piece.

Further, the resistivity of the conductive material is 1-100 Ω·cm, for example, 1 Ω·cm, 2 Ω·cm, 5 Ω·cm, 10 Ω·cm, 20 Ω·cm, 25 Ω·cm, 50 Ω·cm, 100 Ω·cm or in a range composed of any two thereof. Resistivity is a property of the conductive material that blocks current flow. By selecting a conductive material with a suitable resistivity, both the safety and conductivity of the battery can be effectively achieved.

Further, the mass of the conductive material is 40%-98% of the total mass of the protective layer. The protective effect of the conductive material on the positive electrode current collector cannot be realized in the case of too low content of the conductive material, and thus the conductivity of the positive electrode piece is affected.

The binder may be a conventional binder in the art, and specifically include one or more of polyvinylidene fluoride, acrylic acid-modified polyvinylidene fluoride, polyacrylate, polyimide, styrene-butadiene rubber, or styrene-propylene rubber. The mass of the binder is 2-60% of the total mass of the protective layer.

The positive electrode active material layer includes a positive electrode active material, a conductive agent and a binder. The length of the positive electrode active material layer is greater than or equal to the length of the protective layer.

Taking a lithium-ion battery as an example, the positive electrode active material is one or more of lithium cobalt oxide, lithium nickel cobalt manganese oxide, lithium nickel cobalt aluminum oxide, lithium iron phosphate, or lithium manganese oxide; the conductive agent includes one or more of conductive carbon black, carbon nanotubes, conductive graphite, or graphene; the binder includes one or more of polyvinylidene fluoride (PVDF), acrylic modified PVDF, polyacrylate polymer, polyimide, styrene-butadiene rubber, or styrene-propylene rubber.

The positive electrode piece also includes a positive electrode tab 300, which serves as a conductor for the positive electrode piece to conduct with an external circuit. It can be configured according to conventional technical means in the art, which will not be elaborated herein in detail in the present application.

A method for preparing the positive electrode piece provided by the present application includes the following steps: firstly, preparing a protective layer slurry and a positive electrode active material layer slurry respectively, specifically, the method for preparing the protective layer slurry including: mixing a conductive material and a binder at a certain mass ratio and dispersing them in a solvent, adjusting the solid content of dispersed solution, and preparing into the protective layer slurry; and the method for preparing the positive electrode active material layer slurry including: mixing a positive electrode active material, a conductive agent and a binder at a certain mass ratio and dispersing them in a solvent, adjusting the solid content of dispersed solution, and then preparing into the positive electrode active material layer slurry; next, coating the protective layer slurry on the first surface and the second surface of the positive electrode current collector to obtain a protective layer, and then coating the prepared positive electrode active material layer slurry on the surface of the protective layer away from the positive electrode current collector to obtain a positive electrode active material layer; then, cutting the two ends of the positive electrode active material layer so that the end surfaces of the positive electrode active material layer are flush with those of the positive electrode current collector; finally, welding a tab on the surface of the positive electrode current collector to obtain a positive electrode piece.

The electrode assembly further includes a negative electrode piece and a separator that are wound and formed from the inside to the outside. The separator is located between the positive electrode piece and the negative electrode piece. The negative electrode piece includes a negative electrode current collector 201, a negative electrode active material layer 202 and a negative electrode tab 400. The negative electrode piece and the separator are conventional materials in the art. The person skilled in the art may select appropriate materials according to actual needs and obtain the electrode assembly by winding through a winding process.

In summary, the present application can eliminate the non-coated foil zones on the surface of the positive electrode current collector, reduce the risk of short circuit between the positive electrode current collector and the negative electrode active material layer, and improve the safety performance of the battery by simultaneously arranging the functional layers on the upper surface and the lower surface of the positive electrode current collector, and making the length of the functional layer the same as the length of the positive electrode current collector; at the same time, the protective layer includes a conductive material, which can take into account the conductivity of the positive electrode piece and improve the cycle performance of the battery.

A second aspect of the present application provides a battery, including the electrode assembly as described in the foregoing.

The electrode assembly provided by the first aspect of the present application is sealed inside a battery housing with an electrolyte injected, and then a battery is obtained after conventional processes such as formation. The battery provided by the present application includes the above-mentioned electrode assembly, and thus has good safety performance and cycle performance.

The following is described in detail with reference to specific examples.

### Example 1

An electrode assembly provided by the present example has a structure as shown in FIG. 3, including a positive electrode piece and a negative electrode piece that are wound from the inside to the outside. The positive electrode piece has a structure as shown in FIG. 4, including a positive electrode current collector of aluminum foil, protective layers and positive electrode active material layers, where:
the protective layer includes 95 parts by mass of a second conductive material and 5 parts by mass of polyvinylidene fluoride (PVDF), the second conductive material includes a matrix particle TiO₂, the coating layer includes Sb-doped SnO₂, and a mass ratio of the matrix particle to the coating layer is 9:1;
the positive electrode active material layer includes 96 parts by mass of lithium cobalt oxide, 1 part by mass of carbon black, 1 part by mass of carbon nanotubes, and 2 parts by mass of polyvinylidene fluoride (PVDF).

The negative electrode piece includes a negative electrode current collector of copper foil and negative electrode active material layers arranged on the surfaces of the negative electrode current collector of copper foil, and each negative electrode active material layer includes 96 parts by mass of artificial graphite, 1 part by mass of carbon black, 1.5 parts by mass of styrene-butadiene rubber and 1.5 parts by mass of sodium carboxymethyl cellulose.

The thickness of the protective layer located on the upper surface of the positive electrode current collector of aluminum foil is 3 μm, and the thickness of the positive electrode active material layer is 45 μm.

The method for preparing the electrode assembly provided by the present example includes the following steps:
step 1: mixing a second conductive material and polyvinylidene fluoride (PVDF) at the above mass fractions and dispersing them in a solvent of NMP (N-methyl-2-pyrrolidone), adjusting the solid content of dispersed solution to 40%, and preparing into a protective layer slurry;
step 2: mixing lithium cobalt oxide, carbon black, carbon nanotube and PVDF at the above mass fractions and dispersing them in a solvent of NMP, adjusting the solid content of dispersed solution to 70%, and preparing into a positive electrode active material layer slurry;
step 3: coating the protective layer slurry obtained in step 1 on the first surface and the second surface of the positive electrode current collector of aluminum foil to obtain protective layers, then coating the positive electrode active material layer slurry obtained in step 2 on the surface of each protective layer away from the positive electrode current collector, and drying to obtain a positive electrode piece;
step 4: mixing artificial graphite, carbon black, styrene-butadiene rubber and sodium carboxymethyl cellulose at the above mass fractions and dispersing them in a solvent of deionized water, adjusting the solid content of dispersed solution to 40% to prepare into a negative electrode active material layer slurry, coating the prepared negative electrode active material layer slurry on the surface of the negative electrode current collector of copper foil, and drying to obtain the negative electrode piece;
step 5: roll pressing the positive electrode piece and the negative electrode piece to a designed thickness using a roller, making the positive electrode piece and the negative electrode piece to a designed width using a slitting machine, and welding a positive electrode tab and a negative electrode tab on the positive electrode piece and the negative electrode piece respectively;
step 6: placing a separator between the positive electrode piece and the negative electrode piece, winding them according to the mode as shown in FIG. 3 to obtain an electrode assembly, and applying adhesive for fixation.

### Example 2

The electrode assembly provided by the present example may be referred to Example 1, with the difference that the thickness of the protective layer is 2 μm.

### Example 3

The electrode assembly provided by the present example may be referred to Example 1, with the difference that the thickness of the protective layer is 1 μm.

### Example 4

The electrode assembly provided by the present example may be referred to Example 1, with the difference that the thickness of the protective layer is 4 μm.

### Example 5

The electrode assembly provided by the present example may be referred to Example 1, with the difference that the thickness of the protective layer is 5 μm.

### Example 6

The electrode assembly provided by the present example may be referred to Example 1, with the difference that the second conductive material includes 98% of matrix particles TiO₂ and 2% of Sb-doped SnO₂ coating layer.

### Example 7

The electrode assembly provided by the present example may be referred to Example 1, with the difference that the second conductive material includes 60% of matrix particles TiO₂ and 40% of Sb-doped SnO₂ coating layer.

### Example 8

The electrode assembly provided by the present example may be referred to Example 1, with the difference that the protective layer includes the first conductive material SnO₂.

### Example 9

The electrode assembly provided by the present example may be referred to Example 1, with the difference that the second conductive material includes 90% of matrix particles Al₂O₃ and 10% of Sb-doped SnO₂ coating layer.

### Comparative Example 1

The electrode assembly provided by the present comparative example is shown in FIG. 6, that is, the positive electrode piece includes a positive electrode current collector, a protective layer arranged on the surface of the positive electrode current collector, and a positive electrode active material layer. However, unlike example 1, a large number of non-coated foil zones exist on the surface of the positive electrode current collector.

### Comparative Example 2

The electrode assembly provided by the present comparative example is shown in FIG. 6, that is, the positive electrode piece includes a positive electrode current collector, a protective layer arranged on the surface of the positive electrode current collector, and a positive electrode active material layer. However, unlike example 2, a large number of non-coated foil zones exist on the surface of the positive electrode current collector.

### Comparative Example 3

The electrode assembly provided by the present comparative example is shown in FIG. 6, that is, the positive electrode piece includes a positive electrode current collector, a protective layer arranged on the surface of the positive electrode current collector, and a positive electrode active material layer. However, unlike example 3, a large number of non-coated foil zones exist on the surface of the positive electrode current collector.

### Comparative Example 4

The electrode assembly provided by the present comparative example is shown in FIG. 6, that is, the positive electrode piece includes a positive electrode current collector, a protective layer arranged on the surface of the positive electrode current collector, and a positive electrode active material layer. However, unlike example 4, a large number of non-coated foil zones exist on the surface of the positive electrode current collector.

### Comparative Example 5

The electrode assembly provided by the present comparative example is shown in FIG. 6, that is, the positive electrode piece includes a positive electrode current collector, a protective layer arranged on the surface of the positive electrode current collector, and a positive electrode active material layer. However, unlike example 5, a large number of non-coated foil zones exist on the surface of the positive electrode current collector.

### Comparative Example 6

The electrode assembly provided by the present comparative example is shown in FIG. 1, that is, the positive electrode piece includes a positive electrode current collector and a positive electrode active material layer arranged on the surface of the positive electrode current collector, not including a protective layer.

The electrode assemblies provided by examples 1-9 and comparative examples 1-6 are encapsulated using an aluminum-laminated film, subsequently baked until the moisture content is qualified, and an electrolyte is injected to obtain lithium-ion batteries. The batteries are then tested for safety performance. The methods for testing are as follows, and the test results are shown in Table 1.

Needle puncture test: 30 identical lithium-ion batteries are prepared, fully charged, and placed on the test bench of the needle puncture test equipment. The middle of the lithium-ion battery is pierced by a tungsten steel needle having a diameter of 3 mm and a needle tip length of 3.62 mm at a speed of 100 mm/s. Lithium-ion batteries that do not catch fire or explode are considered to have passed the test.

Foreign body extrusion test: 30 identical lithium-ion batteries are prepared, fully charged, and placed on the test bench of the extrusion equipment. An M2*4 (screw diameter of 2 mm, and screw length of 4 mm) screw is placed in the middle of the battery, then the extrusion equipment is started with an extrusion plate pressing down at a speed of 100 mm/s, and the test is stopped when its extrusion force reaches 13 KN. The batteries that do not catch fire or explode are considered to have passed the test.

45° C. cycle test: at 45° C., the lithium-ion batteries are charged and discharged at 1.5 C charge/0.5 C discharge, and the discharge capacity Q2 of the 500th charge and discharge and the discharge capacity Q1 of the first charge and discharge are recorded. The capacity retention rate=Q2/Q1×100%.

TABLE 1

| | | | | | | | Pass rate | Pass rate | |
|---|---|---|---|---|---|---|---|---|---|
| | | | | | | | of needle | of screw | |
| | Ingredient of protective layer | | | | Thickness | Resistance | puncture | extrusion | 45° C. |
| | | | Resistivity of | | of | of | (Pass | (Pass | cycle |
| | | | conductive | Dv50 of | protective | protective | quantity/ | quantity/ | capacity |
| | | | material | conductive | layer | layer | test | test | retention |
| | Type of conductive material | | (Ω · cm) | material (μm) | (μm) | (mΩ) | quantity) | quantity) | rate |
| Example 1 | Second | 90% matrix | 20 | 0.4 | 3 | 200 | 30/30 | 30/30 | 89.2% |
| | conductive | particles of TiO₂ | | | | | | | |
| | material | 10% coating layer | | | | | | | |
| | | of Sb-doped SnO₂ | | | | | | | |
| Example 2 | Second | 90% matrix | 20 | 0.4 | 2 | 130 | 28/30 | 28/30 | 89.4% |
| | conductive | particles of TiO₂ | | | | | | | |
| | material | 10% coating layer | | | | | | | |
| | | of Sb-doped SnO₂ | | | | | | | |
| Example 3 | Second | 90% matrix | 20 | 0.4 | 1 | 60 | 25/30 | 24/30 | 89.6% |
| | conductive | particles of TiO₂ | | | | | | | |
| | material | 10% coating layer | | | | | | | |
| | | of Sb-doped SnO₂ | | | | | | | |
| Example 4 | Second | 90% matrix | 20 | 0.4 | 4 | 280 | 30/30 | 30/30 | 89.1% |
| | conductive | particles of TiO₂ | | | | | | | |
| | material | 10% coating layer | | | | | | | |
| | | of Sb-doped SnO₂ | | | | | | | |
| Example 5 | Second | 90% matrix | 20 | 0.4 | 5 | 310 | 30/30 | 30/30 | 88.9% |
| | conductive | particles of TiO₂ | | | | | | | |
| | material | 10% coating layer | | | | | | | |
| | | of Sb-doped SnO₂ | | | | | | | |
| Example 6 | Second | 98% matrix | 100 | 0.4 | 3 | 1570 | 30/30 | 30/30 | 85.4% |
| | conductive | particles of TiO₂ | | | | | | | |
| | material | 2% coating layer | | | | | | | |
| | | of Sb-doped SnO₂ | | | | | | | |
| Example 7 | Second | 60% matrix | 2 | 0.4 | 3 | 32 | 28/30 | 28/30 | 89.7% |
| | conductive | particles of TiO₂ | | | | | | | |
| | material | 40% coating layer | | | | | | | |
| | | of Sb-doped SnO₂ | | | | | | | |
| Example 8 | First | SnO₂ | 80 | 0.05 | 3 | 10 | 26/30 | 26/30 | 85.9% |
| | conductive | | | | | | | | |
| | material | | | | | | | | |
| Example 9 | Second | 90% matrix | 20 | 0.4 | 3 | 200 | 30/30 | 30/30 | 89.8% |
| | conductive | particles of Al₂O₃ | | | | | | | |
| | material | 10% coating layer | | | | | | | |
| | | of Sb-doped SnO₂ | | | | | | | |
| Comparative | Second | 90% matrix | 20 | 0.4 | 3 | 200 | 16/30 | 14/30 | 89.3% |
| example 1 | conductive | particles of TiO₂ | | | | | | | |
| | material | 10% coating layer | | | | | | | |
| | | of Sb-doped SnO₂ | | | | | | | |
| Comparative | Second | 90% matrix | 20 | 0.4 | 2 | 130 | 12/30 | 11/30 | 89.4% |
| example 2 | conductive | particles of TiO₂ | | | | | | | |
| | material | 10% coating layer | | | | | | | |
| | | of Sb-doped SnO₂ | | | | | | | |
| Comparative | Second | 90% matrix | 20 | 0.4 | 1 | 60 | 10/30 | 9/30 | 89.7% |
| example 3 | conductive | particles of TiO₂ | | | | | | | |
| | material | 10% coating layer | | | | | | | |
| | | of Sb-doped SnO₂ | | | | | | | |
| Comparative | Second | 90% matrix | 20 | 0.4 | 4 | 280 | 21/30 | 23/30 | 89.2% |
| example 4 | conductive | particles of TiO₂ | | | | | | | |
| | material | 10% coating layer | | | | | | | |
| | | of Sb-doped SnO₂ | | | | | | | |
| Comparative | Second | 90% matrix | 20 | 0.4 | 5 | 310 | 24/30 | 23/30 | 88.9% |
| example 5 | conductive | particles of TiO₂ | | | | | | | |
| | material | 10% coating layer | | | | | | | |
| | | of Sb-doped SnO₂ | | | | | | | |
| Comparative | — | | | | | | 0/30 | 0/30 | 89.2% |
| example 6 | | | | | | | | | |

According to Comparative example 6, it can be seen that arranging a protective layer on the surface of the positive electrode current collector helps to improve the pass rate of the batteries. According to examples 1-5 and comparative examples 1-5, it can be seen that the protective layers are provided on the all non-coated foil zones of the positive electrode current collector away from the starting point of winding, thereby increasing the test pass rate of the batteries and improving the safety performance of the batteries. According to example 8, it can be seen that compared with the first conductive material, the second conductive material is more conducive to improving the cycle performance and safety performance of the batteries. According to example 6, it can be seen that the content of coating layer in the second conductive material is too low, resulting in a decrease in the cycle performance of the batteries.

Finally, it should be noted that the above embodiments are only used to illustrate the technical solutions of the present application, rather than limiting them; although detailed description has been made to the present application with reference to the aforementioned embodiments, the person skilled in the art should understand that they may still modify the technical solutions recorded in the aforementioned embodiments, or perform equivalent replacements on some or all of the technical features; however, these modifications or replacements do not make the essence of the corresponding technical solutions deviate from the scope of technical solutions in various embodiments of the present application.

What is claimed is:

1. An electrode assembly, comprising a positive electrode piece formed by winding, wherein the positive electrode piece comprises a positive electrode current collector and a functional layer, and wherein:
the positive electrode current collector comprises a first surface and a second surface which are parallel and opposite to each other, the first surface and the second surface of the positive electrode current collector are each provided with the functional layer, and a length of the functional layer is the same as a length of the positive electrode current collector;
the functional layer comprises a protective layer and a positive electrode active material layer, the protective layer is arranged between the positive electrode current collector and the positive electrode active material layer, and a length of the protective layer is less than or equal to a length of the positive electrode active material layer;
the protection layer comprises a conductive material and a binder.

2. The electrode assembly according to claim 1, wherein the length of the protective layer is less than or equal to the length of the positive electrode current collector.

3. The electrode assembly according to claim 1, wherein a thickness of the protective layer is 1-10 μm.

4. The electrode assembly according to claim 1, wherein a resistance of the protective layer is 10-2000 mΩ.

5. The electrode assembly according to claim 1, wherein a peeling force between the protective layer and the positive electrode current collector is greater than a peeling force between the protective layer and the positive electrode active material layer.

6. The electrode assembly according to claim 1, wherein the conductive material comprises at least one of a first conductive material and a second conductive material, and the first conductive material comprises one or more of SnO₂, In₂O₃, Sb-doped SnO₂, F-doped SnO₂, or Sn-doped In₂O₃; the second conductive material comprises a matrix particle and a coating layer for coating a surface of the matrix particle, and the matrix particle is one or more material selected from aluminum oxide, magnesium oxide, titanium oxide, zinc oxide, silicon oxide, boehmite, cobalt oxide, iron phosphate, lithium iron phosphate, lithium nickel cobalt manganese oxide, or lithium iron manganese phosphate, and the coating layer comprises one or more of carbon, SnO₂, In₂O₃, Sb-doped SnO₂, F-doped SnO₂, or Sn-doped In₂O₃.

7. The electrode assembly according to claim 2, wherein the conductive material comprises at least one of a first conductive material and a second conductive material, and the first conductive material comprises one or more of SnO₂, In₂O₃, Sb-doped SnO₂, F-doped SnO₂, or Sn-doped In₂O₃; the second conductive material comprises a matrix particle and a coating layer for coating a surface of the matrix particle, and the matrix particle is one or more material selected from aluminum oxide, magnesium oxide, titanium oxide, zinc oxide, silicon oxide, boehmite, cobalt oxide, iron phosphate, lithium iron phosphate, lithium nickel cobalt manganese oxide, or lithium iron manganese phosphate, and the coating layer comprises one or more of carbon, SnO₂, In₂O₃, Sb-doped SnO₂, F-doped SnO₂, or Sn-doped In₂O₃.

8. The electrode assembly according to claim 3, wherein the conductive material comprises at least one of a first conductive material and a second conductive material, and the first conductive material comprises one or more of SnO₂, In₂O₃, Sb-doped SnO₂, F-doped SnO₂, or Sn-doped In₂O₃; the second conductive material comprises a matrix particle and a coating layer for coating a surface of the matrix particle, and the matrix particle is one or more material selected from aluminum oxide, magnesium oxide, titanium oxide, zinc oxide, silicon oxide, boehmite, cobalt oxide, iron phosphate, lithium iron phosphate, lithium nickel cobalt manganese oxide, or lithium iron manganese phosphate, and the coating layer comprises one or more of carbon, SnO₂, In₂O₃, Sb-doped SnO₂, F-doped SnO₂, or Sn-doped In₂O₃.

9. The electrode assembly according to claim 4, wherein the conductive material comprises at least one of a first conductive material and a second conductive material, and the first conductive material comprises one or more of SnO₂, In₂O₃, Sb-doped SnO₂, F-doped SnO₂, or Sn-doped In₂O₃; the second conductive material comprises a matrix particle and a coating layer for coating a surface of the matrix particle, and the matrix particle is one or more material selected from aluminum oxide, magnesium oxide, titanium oxide, zinc oxide, silicon oxide, boehmite, cobalt oxide, iron phosphate, lithium iron phosphate, lithium nickel cobalt manganese oxide, or lithium iron manganese phosphate, and the coating layer comprises one or more of carbon, SnO₂, In₂O₃, Sb-doped SnO₂, F-doped SnO₂, or Sn-doped In₂O₃.

10. The electrode assembly according to claim 5, wherein the conductive material comprises at least one of a first conductive material and a second conductive material, and the first conductive material comprises one or more of SnO₂, In₂O₃, Sb-doped SnO₂, F-doped SnO₂, or Sn-doped In₂O₃; the second conductive material comprises a matrix particle and a coating layer for coating a surface of the matrix particle, and the matrix particle is one or more material selected from aluminum oxide, magnesium oxide, titanium oxide, zinc oxide, silicon oxide, boehmite, cobalt oxide, iron phosphate, lithium iron phosphate, lithium nickel cobalt manganese oxide, or lithium iron manganese phosphate, and the coating layer comprises one or more of carbon, SnO₂, In₂O₃, Sb-doped SnO₂, F-doped SnO₂, or Sn-doped In₂O₃.

11. The electrode assembly according to claim 6, wherein a mass of the coating layer is 5-40% of a total mass of the second conductive material.

12. The electrode assembly according to claim 1, wherein a Dv50 of the conductive material is 0.05-5 μm.

13. The electrode assembly according to claim 6, wherein a Dv50 of the conductive material is 0.05-5 μm.

14. The electrode assembly according to claim 1, wherein a resistivity of the conductive material is 1-100 Ω·cm.

15. The electrode assembly according to claim 6, wherein a resistivity of the conductive material is 1-100 Ω·cm.

16. The electrode assembly according to claim 1, wherein a mass of the conductive material is 40%-98% of a total mass of the protective layer.

17. The electrode assembly according to claim 6, wherein a mass of the conductive material is 40%-98% of a total mass of the protective layer.

18. The electrode assembly according to claim 1, wherein a mass of the binder is 2-60% of a total mass of the protective layer.

19. The electrode assembly according to claim 1, wherein the binder comprises one or more of polyvinylidene fluoride, acrylic acid-modified polyvinylidene fluoride, polyacrylate, polyimide, styrene-butadiene rubber, or styrene-propylene rubber.

20. A battery, comprising the electrode assembly according to claim 1.
